(19) United States
(12) Patent Application Publication
(10) Pub. No.: US 2005/0272471 A1
(43) Pub. Date: Dec. 8, 2005

(54) Base unit with interchangeable interface for remote unit

(75) Inventor: Stephen Kenneth Sherman, Alpharetta, GA (US)

Correspondence Address: MERCHANT & GOULD PC, P.O. BOX 2903, MINNEAPOLIS, MN, 55402-0903, US

(73) Assignee: BellSouth Intellectual Property Corporation

(21) Appl. No.: 10/861,140

(22) Filed: Jun. 4, 2004

(51) Int. Cl. H04B 7/00

(52) U.S. Cl. 455/561; 455/41.2

(57) ABSTRACT

A base station capable of receiving remote devices, such as cellular phones or PDAs, from different manufacturers or otherwise lacking a common footprint for connecting to a cradle. The base station includes a base unit and an intermediate unit connectable to the base unit to establish electrical interconnection for power and/or data. The intermediate unit is configured to accept the docking footprint of a particular remote device and to complete the electrical interconnection with the base unit through the intermediate unit. The base unit can interconnect with other remote units having different footprints, by substituting a different intermediate unit complementary to that different footprint.

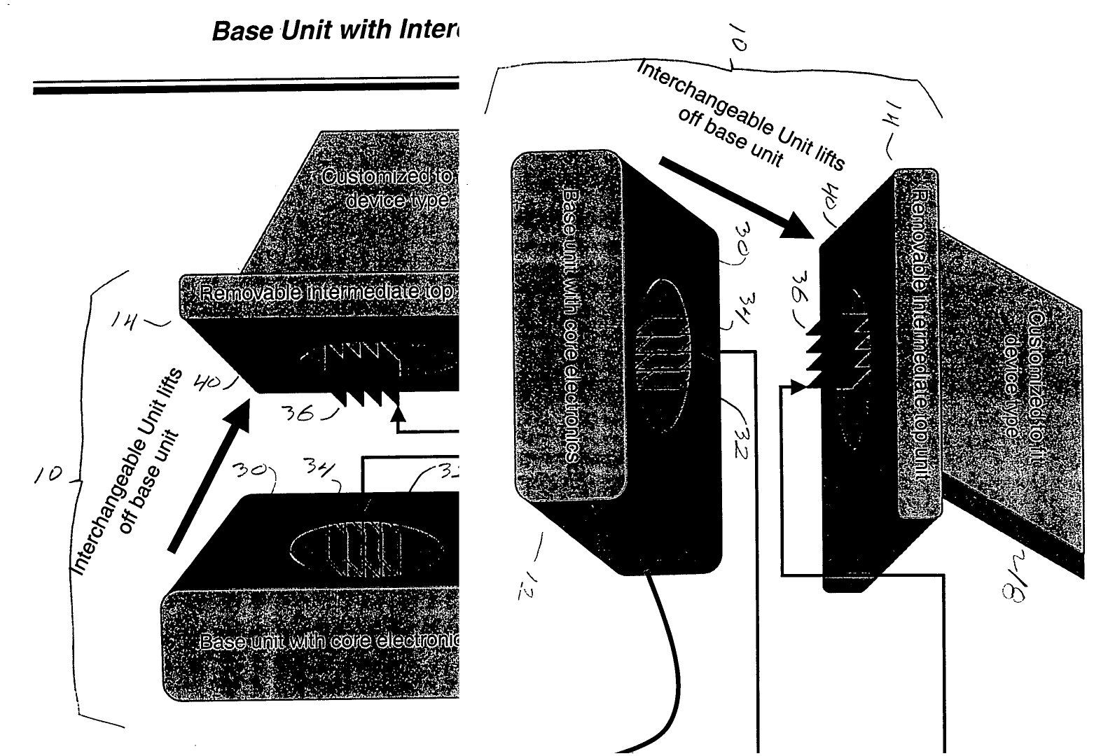

### FIELD OF THE INVENTION

This invention relates in general to base units used with remote devices, and relates in particular to adapting a base unit for use with a remote device configured differently from the remote device for which the base unit is designed.

### BACKGROUND OF THE INVENTION

Various kinds of electronic or electrical devices are intended for selectable use in conjunction with a base unit. In a typical example, the remote device is operable separate from the base unit or station, sometimes referred to as a cradle, for receiving the remote device. The remote device may be attached or docked to the base station, for example, to recharge a battery associated with the remote device, to establish a data link between the remote device and the base station, or for other purposes. Examples of remote devices often used with a base station or cradle include devices such as cell phone handsets, personal digital assistants (PDAs), and other portable or mobile electronic devices without limitation. The user of a PDA, for example, may periodically dock that device in a cradle connected to a personal computer in a manner known in the art, thereby establishing a data signal connection between the PDA and the computer for synchronizing certain files (e.g., calendar files) between the PDA and the computer. At the same time, the docked PDA typically is connected through the docking connection to a source of charging current that recharges or maintains a charge in the battery of the PDA.

Wireless communication units such as cellular handsets and two-way radios may utilize a docking unit or base station to provide operating or charging power to a remote unit and, in some instances, to establish a data link with the docked remote unit. In the simplest example, a wireless handset may be placed in a cradle to establish an electrical power connection between the handset and a source of recharging current available at the cradle. Such cradles may be located at the user's workstation or at a suitable home location, or may also be mounted on the dashboard or other convenient location in an automobile so that the handset is supported ready for convenient access while connected to a source of charging current. Moreover, certain wireless applications rely on docking the handset to a cradle or base station so as to establish or change a particular communication interrelation.

Although cradles and similar docking devices permit quick and easy interconnection between a remote unit and a data link or power source, or both, the docking devices generally are designed for physical and electrical interfacing with a particular kind of remote unit. Thus, a cradle intended for use with a wireless handset is configured to accept only handsets from a particular manufacture, such as Nokia, but is not capable of accepting handsets from another manufacturer. The practical result is that users of wireless handsets or other portable electronic devices must acquire a cradle or base unit configured to accept and function only with that particular remote unit. Moreover, there can be no assurance that different models of handsets or similar wireless devices from the same maker will have a common physical footprint (including electrical connections as well as structural configuration) permitting operational interconnection with a particular cradle. Users of devices such as wireless handsets and PDAs sometimes keep those devices for only a year or less, thereafter exchanging the units for devices considered to offer improvements in size, functionality, or other features. If a user were to swap the wireless handset for a unit having a different footprint, that person would also need to purchase a new base station merely to maintain the same operational interrelation that existed between the original base station and the original handset. This incompatibility between handsets or other remote units, and base stations originally intended for a particular such unit, creates an unnecessary expense to the user considering whether to upgrade or replace the remote device.

### SUMMARY OF THE INVENTION

According to exemplary embodiments, and stated in somewhat general terms, the present invention comprises a base station with a separate and interchangeable interface unit adapting the base station to receive and functionally interact with a particular remote unit. The interface unit is received in the base unit in place of the particular remote unit, for which the base unit may be designed. The interface unit, in turn, has a cradle or similar region for receiving the particular remote unit for which the particular interface unit is designed. When the remote unit is docked with the interface unit, an operational interrelation is established between that remote unit and the base unit through the interface unit.

Stated with greater particularity, the present invention in a first disclosed exemplary embodiment has a base station configured to accept an intermediate unit, which may be one of several intermediate units each configured with a cradle or other interface to accept different remote units having engagement portions with unique footprints for physical and functional interconnection with a base station. Different remote units having different engagement portions thus may be docked in structural and functional interaction with a base station common to those different units, by substituting an intermediate unit configured to accept the footprint of the particular remote unit.

Stated with somewhat greater particularity, an interface unit according to another disclosed embodiment of the present invention has a first portion configured to emulate a portion of the particular remote unit that the base unit is designed to accept. This first portion of the interface unit fits within or otherwise interacts with the base unit, in place of that particular remote unit. The interface unit has a second portion configured for receiving a complementary element of the different remote unit, so that the different remote unit may be received in the second portion of the interface unit. With the interface unit thus received in or otherwise operatively associated with the base unit in place of the particular remote unit for which the base unit was designed, a different remote unit may then be functionally interrelated with the base unit by associating that different remote with the second portion of the interface unit.

Stated in further detail, an interface unit according to exemplary embodiments establishes a functional interconnection between the base unit and the different remote unit engaging the interface unit. For example, the present interface unit supplies electric charging current, if available at the particular base unit, to the different remote unit when received by the interface unit. By way of further example, if the base unit is intended to establish data interchange with the particular remote unit for which that base was originally designed, an interface unit according to the present invention can provide the same or similar data interchange between the base unit and a different remote unit. This transfer of charging current and data interchange takes place through circuit elements in the first portion and second portion of the interface unit, which functionally interact with complementary circuit elements respectively in the base unit and the different remote unit, such that the interface unit functionally emulates some or all of the functional attributes available to that different remote unit from a base unit intended for that remote unit.

Other features and advantages of the present invention will become readily apparent from the following detailed description of disclosed embodiments.

### BRIEF DESCRIPTION OF DRAWING FIGURE

The FIGURE is an exploded pictorial view of a base station according to a disclosed exemplary embodiment of the present invention.

### DETAILED DESCRIPTION OF PREFERRED EMBODIMENT

Turning now to the drawing FIGURE, there is shown a base station 10 according to a disclosed exemplary embodiment of the present invention. The base station 10 is comprised of two primary elements, namely, a base unit 12 and an intermediate unit 14 detachably connected to the base unit. The intermediate unit 14 defines a cradle 18 customized for removeably receiving a remote unit (not shown), which may be, for example, a wireless handset of the kind typically used with cellular telephone systems. However, it should be understood that the remote unit does not form part of the present invention, but is discussed herein to illustrate one example of application for the disclosed base station embodiment. Furthermore, those skilled in the art should understand that other embodiments of the present invention may be designed and configured for use with various other kinds of dockable remote devices, for example PDAs, digital voice recorders, digital cameras, and so on, whether or not the remote device functions as a wireless communicator.

A cable 24 extends from the base unit 12 for connection to a suitable source of electrical power, data, or both power and data, for functional interchange with the remote unit intended for use with the base station 10. In applications where the base station 10 is intended only to supply current for charging a battery associated with the remote unit, the cable 24 may extend to a suitable power supply of the kind well known in the art. It is also considered within the scope of the present invention that the intermediate unit 14 could be configured so that the cradle 18 receives only a battery of selected configuration, for receiving charging current. In that case, a user could charge an auxiliary or backup battery in the present apparatus, while the remote unit is removed from the cradle 18 and in use for its intended purpose. In other applications, where the base station 10 provides data communication with the remote unit, the cable 24 may connect to an appropriate source of both data signals and charging current. As a further alternative, in other embodiments the cable 24 may comprise two or more lines extending respectively to a source of charging power and to a data signal source, such as a telephone line, or a data port associated with a personal computer.

The base unit 12 has an upper side 30 with an attachment region 32 for removeably receiving the intermediate unit 14. The attachment region 32 may be recessed into the upper side 30 if desired to provide a secure mounting of the intermediate unit 14 with the base unit. The attachment region 32 preferably has one or more electrical connectors indicated collectively at 34 and operative for establishing electrical communication between the base unit 12 and an intermediate unit 14 when attached to the base unit. Depending on the nature and operation of a particular remote unit and the intended functional interrelation between that remote unit and the base station 10, the one or more electrical connectors 34 may associate with electronic components within the base unit 12 or alternatively may provide nothing more than a pass-through connection to the cable 34 extending from the base unit.

The attachment region 32 of the base unit 12 may also have one or more attachment elements for physically positioning an intermediate unit 14 with respect to the attachment region, and in particular for accurate alignment of the electrical connectors 34 with complementary connecting elements 36 on the underside of the intermediate unit. Suitable attachment elements include, for example, one or more pins extending in the attachment region 32 and mating with corresponding holes or sockets in the confronting underside of the intermediate unit 14, or vice versa.

Turning now to the intermediate unit 14, that unit in a disclosed exemplary embodiment has a lower surface 40 with a portion configured for complementary fit with the attachment region 32 of the base unit 12. The connecting elements 36 on the underside of the intermediate unit 14 are configured to mate with the one or more electrical connectors 34 in the attachment region 32 of the base unit 12, when the intermediate unit is mounted on the base unit.

The upper side of the intermediate unit 12 includes a cradle 18, as previously mentioned, and it will be understood that the cradle is configured to receive a particular kind or model of remote unit. The cradle 18 thus includes at least one electrical connector of a kind and location for interconnection with the remote unit 16 when docked in the cradle 18, so as to establish the appropriate interconnection for charging power and/or data transfer between the remote unit and, through the intermediate unit 14, the base unit 12. The cradle 18 may also have one or more physical guide elements positioned to defined a particular location for placing the remote unit 16 into the cradle so as to establish electrical communication between the electrical connector on the intermediate unit and the complementary connector or connectors of the remote unit. The electrical connector and any physical guide elements define structure complementary to the docking footprint of the particular remote unit for which the intermediate unit is configured.

Use of the base station 10 should now be apparent from the foregoing description. When the user of a particular remote unit acquires a base station 10, that base station will include the base unit 12 and an intermediate unit 14 configured for use with the particular remote unit. That specific configuration usually concerns the shape and layout of the cradle 18 on the intermediate unit, including the physical guide elements and the electrical connectors elements complementary to the footprint of that remote unit, and will be understood that the cradle and corresponding elements are adapted to the footprint of the particular remote unit for which the intermediate unit 14 is intended. The particular remote unit then is docked with or undocked from the base station 10 as desired, with electrical and data connections between the remote and the base station being made through the intermediate unit. However, if the user later decides to replace that particular remote unit with another remote unit, e.g., replacing a cell phone handset or a PDA with a similar device from another manufacturer or one having a different footprint, the user need only replace the intermediate unit 14 instead of acquiring an entire new base station 10 to accommodate the different remote unit. Because the intermediate unit 14 typically contains little or no active electrical or electronic elements, having only the wiring necessary to mate the lower connector on the underside of the remote unit with the pins or other connector elements in the electrical connector intended for interfacing with the footprint of the different remote unit, the cost of replacing the intermediate unit should be a fraction of the cost for acquiring an entire new base station 10.

A modified embodiment can adapt a base unit designed for use with a particular remote unit, to receive another remote unit having a different footprint. According to that modification, an intermediate unit is provided having a first portion configured to emulate the footprint of the particular remote unit for which the base unit is designed, so that the first portion of that intermediate unit can contact or otherwise interface with the base unit in place of that particular remote unit for which the base unit is designed. That intermediate unit further has a second portion configured to receive and functionally interact with the different footprint of the other remote unit, with appropriate power and/or data interconnection between the first and second portions of the intermediate unit. The second portion of the intermediate unit thus functions as a docking station for the other remote unit.

It should be understood that the foregoing relates only to preferred embodiment of the present invention, and that numerals changes and modifications therein may be made without departing from the spirit and scope of the invention as defined in the following claims.

1. A base apparatus for use with remote units having differing engagement configurations, the base apparatus comprising:
a base unit operative for functional interaction with plural remote units and having an engagement portion; and
an intermediate unit selectably attachable to the base unit and having a first portion configured for selective operative interrelation with the engagement portion of the base unit so as to establish a predetermined functional interaction with the base unit;
the intermediate unit having a second portion configured for receiving a complementary element of a predetermined remote unit, the second portion of the intermediate unit being operatively associated with the first portion of the intermediate unit so that a predetermined remote unit received in the second portion of the intermediate unit can establish said functional interaction with the base unit through the intermediate unit,
whereby a different remote unit having an engagement element different from the predetermined remote unit may also be placed in functional interaction with the base unit by substituting a different intermediate unit having a second portion configured for functional interaction with the complementary element of the different remote unit.

2. The apparatus as in claim 1, wherein the base unit is operative to establish an electrical connection with any of plural remote units through the complementary element of the particular remote unit, the apparatus further comprising:
first means associated with the intermediate unit and operative for electrical interrelation with the base unit, thereby emulating the electrical connection with a remote unit; and
second means in the second portion of the intermediate unit configured for electrical interrelation with the complementary element of a predetermined remote unit, the second means being in operative interrelation with the first means and thereby establishing the electrical connection between the base unit and a predetermined remote unit received in the intermediate unit.

3. The apparatus as in claim 2, wherein:
the base unit has an electrical circuit element operative to supply electrical power to the remote unit;
the first means of the intermediate unit includes a first electrical connector configured for mating engagement with the electrical circuit element of the base unit; and
the second means of the intermediate unit is operable for a power connection with the predetermined remote unit so as to supply electrical power from the base unit to the predetermined remote unit.

4. The apparatus as in claim 1, wherein:
the second portion of the intermediate unit has a cradle configured to receive the predetermined remote unit so as to establish the electrical connection therewith.

5. The apparatus as in claim 1, in which the remote units comprise wireless devices having complementary elements to establish a power connection and a data connection with the wireless device, and wherein:
the base unit is operative to provide the power connection and the data connection to the first portion of the intermediate unit; and
the second portion of the intermediate element is configured to receive and functionally interrelate with the complementary element of a predetermined wireless device, so as to establish the power connection and the data connection between the predetermined wireless device and the base unit through the intermediate unit.

6. Apparatus for use with a base unit configured to receive and functionally interrelate with a complementary element of a particular remote unit, so that the base unit can receive and functionally interrelate with another remote unit having a different complementary element, the apparatus comprising:
a first portion of an intermediate unit configured to emulate the complementary element of the particular remote unit so that the first portion is selectably receivable in operative interrelation with the base unit, in place of the particular remote unit for which the base unit is configured; and
a second portion of the intermediate unit configured for receiving and functionally interrelating with the different complementary element of the other remote unit so that the other remote unit is in operative interrelation with the second portion of the intermediate unit,
whereby the other remote unit as received in the second portion of the intermediate unit is in functional interrelation with the base unit in place of the particular remote unit for which the base unit is configured.

7. The apparatus as in claim 6, for use with a base unit having a cradle to receive the complementary element of the particular remote unit, and wherein:
the second portion of the intermediate unit has a cradle configured to receive the other remote unit so as to establish the electrical connection therewith; and
the first portion of the intermediate unit is operative to emulate the complementary element of the particular remote unit so as to establish the electrical operative interrelation therewith.

8. The apparatus as in claim 6, for use with a particular remote unit that includes a particular wireless device having the complementary element that the base unit is configured to receive so as to establish a charging power connection and a data function with the particular wireless device, and wherein:
the first portion of the intermediate element is operative to emulate the complementary element of the particular wireless device; and
the second portion of the intermediate element is operative to receive and functionally interrelate with the different complementary element of a different wireless device, so as to establish the charging power connection and the data function with the different wireless device.
